(19) United States
(12) Patent Application Publication
(10) Pub. No.: US 2012/0245756 A1
(43) Pub. Date: Sep. 27, 2012

(54) DRIVER ASSISTANCE SYSTEM

(75) Inventors: Troy Otis COOPRIDER, White Lake, MI (US); Shi Shen, Farmington Hills, MI (US); Faroog Ibrahim, Dearborn Heights, MI (US)

(73) Assignee: TK Holdings Inc.

(21) Appl. No.: 13/427,806

(22) Filed: Mar. 22, 2012

Related U.S. Application Data
(60) Provisional application No. 61/466,777, filed on Mar. 23, 2011.
(60) Provisional application No. 61/466,876, filed on Mar. 23, 2011.

(51) Int. Cl. G06F 7/00

(52) U.S. Cl. 701/1

(57) ABSTRACT

A system and method of assisting a driver of a vehicle by providing driver and vehicle feedback control signals is disclosed herein. The system and method includes receiving location data of the vehicle from a GPS unit, retrieving navigation characteristics stored in a map database based on the location data, generating a most probable future path for the vehicle, determining the locations of upcoming zones on the most probable future path based on the retrieved navigation characteristics using a processor, generating vehicle speed data at a vehicle sensor unit, and determining if the vehicle speed data exceeds a speed threshold associated with the upcoming zone on the most probable path.

### CROSS-REFERENCE TO RELATED PATENT APPLICATIONS

This application claims priority from Provisional Application US Application 61/466,777, filed Mar. 23, 2011, and from Provisional Application US Application 61/466,876, filed Mar. 23, 2011. The foregoing provisional applications are incorporated herein by reference in its entirety.

### BACKGROUND OF THE INVENTION

Driver assistance systems are becoming more and more prevalent in vehicles. Driver assistance systems can help a driver deal with an upcoming road hazard condition, whether it be an upcoming acute curve in the road or an accident that has occurred in a portion of the road in which the driver is driving towards.

Zone warning systems such as speed zone warning systems and no passing zone warning systems alert the driver when the vehicle speed is above the posted speed limit on a segment of road the vehicle is traveling on. Optical sensors are the dominant technology to detect speed signs and no passing zone signs. Color cameras are typically used to help detect a traffic sign on the roadside and to distinguish between different types of traffic signs, and a classification algorithm is typically used to recognize the printed speed on the sign.

Like most vision systems, optical sensor based zone warning inevitably suffers from adverse illumination and weather conditions when the assistance is needed most. A method of detecting speed or no-passing zone warning using visual sensors suffers from several limitations. The visual sensors can fail to detect signs in complex environment (e.g., downtown streets). The visual sensors can also fail to detect signs because of different sign shapes and locations. The visual sensors can also incorrectly recognize speeds because of misclassification at high speeds. The visual sensors can also suffer from degraded detection/recognition at night, in rain or snow, when facing low angle sunlight (e.g., at dawn or dusk).

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic diagram of a vehicle control area network;

FIG. 2 is a schematic diagram of various vehicle system components and a general driver assistance system;

FIG. 3 is a schematic diagram of a driver assistance system depicting driver assistance modules related to zone determinations;

FIG. 4 depicts a graphical representation of a generated path tree;

FIG. 5 depicts a graphical representation of a future most probable path determination; and

FIG. 6 is a general flow chart of a method for producing a zone related control signal.

### SUMMARY OF THE INVENTION

According to an exemplary embodiment, a driver assistance system includes a map database including navigation characteristics related to road locations, a GPS unit that receives location data of the vehicle, a map matching module configured to receive the location data of the vehicle and retrieve navigation characteristics relevant to the location data using a processing circuit, and a prediction module configured to generate a most probable future path for the vehicle and to determine the locations of upcoming zones on the most probable future path. The driver assistance system further includes a vehicle sensor unit configured to generate vehicle speed data and a warning module configured to determine if the vehicle speed data exceeds a speed threshold associated with the upcoming zone on the most probable path.

According to another exemplary embodiment, a driver assistance method includes receiving location data of the vehicle from a GPS unit, retrieving navigation characteristics stored in a map database based on the location data, generating a most probable future path for the vehicle, determining the locations of upcoming zones on the most probable future path based on the retrieved navigation characteristics using a processor, generating vehicle speed data at a vehicle sensor unit, and determining if the vehicle speed data exceeds a speed threshold associated with the upcoming zone on the most probable path.

### DETAILED DESCRIPTION

Before describing in detail the particular improved system and method, it should be observed that the several disclosed embodiments include, but are not limited to a novel structural combination of conventional data and/or signal processing components and communications circuits, and not in the particular detailed configurations thereof. Accordingly, the structure, methods, functions, control and arrangement of conventional components and circuits have, for the most part, been illustrated in the drawings by readily understandable block representations and schematic diagrams, in order not to obscure the disclosure with structural details which will be readily apparent to those skilled in the art, having the benefit of the description herein. Further, the disclosed embodiments are not limited to the particular embodiments depicted in the exemplary diagrams, but should be construed in accordance with the language in the claims.

In general, according to various exemplary embodiments, a driver assistance system includes a digital map system, vehicle sensor input, vision system input, location input, such as global positioning system (GPS) input, and various driver assistance modules used to make vehicle related determinations based on driver assistance system input. The various driver assistance modules may be used to provide indicators or warnings to a vehicle passenger or may be used to send a control signal to a vehicle system component such as a vehicle engine control unit, or a vehicle steering control unit, for example, by communicating a control signal through a vehicle control area network (CAN).

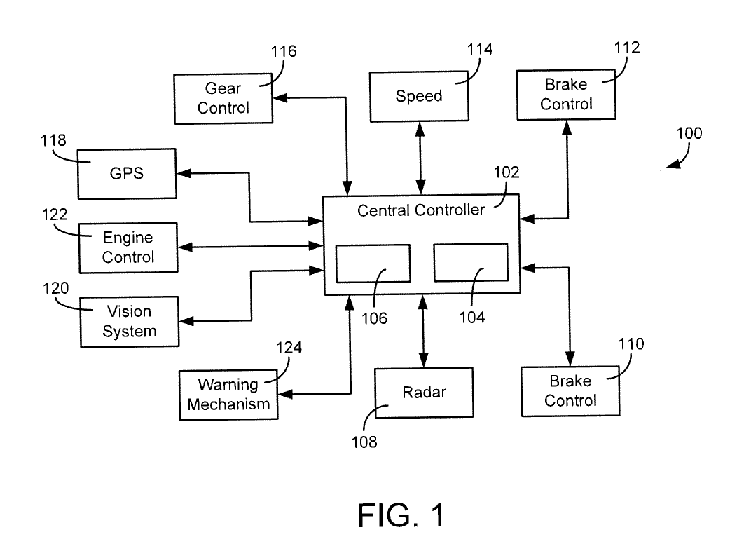

Referring to FIG. 1, a block diagram of a vehicle communication network 100 is shown, according to an exemplary embodiment. Vehicle communication network 100 is located within a vehicle body and allows various vehicle sensors including a radar sensor 108, a speed sensor and/or accelerometer 114, and a vehicle vision system 120 which may include a stereovision camera and/or a monovision camera. In addition, communication network 100 receives vehicle location data from GPS module 118. Furthermore, communication network 100 communicates with various vehicle control modules including brake control modules 110 and 112, gear control module 116, engine control module 122, and warning mechanism module 124, for example. Central controller 102 includes at least one memory 104 and at least one processing unit 106. According to one exemplary embodiment vehicle communication network 100 is a control area network (CAN) communication system and prioritizes communications in the network using a CAN bus.

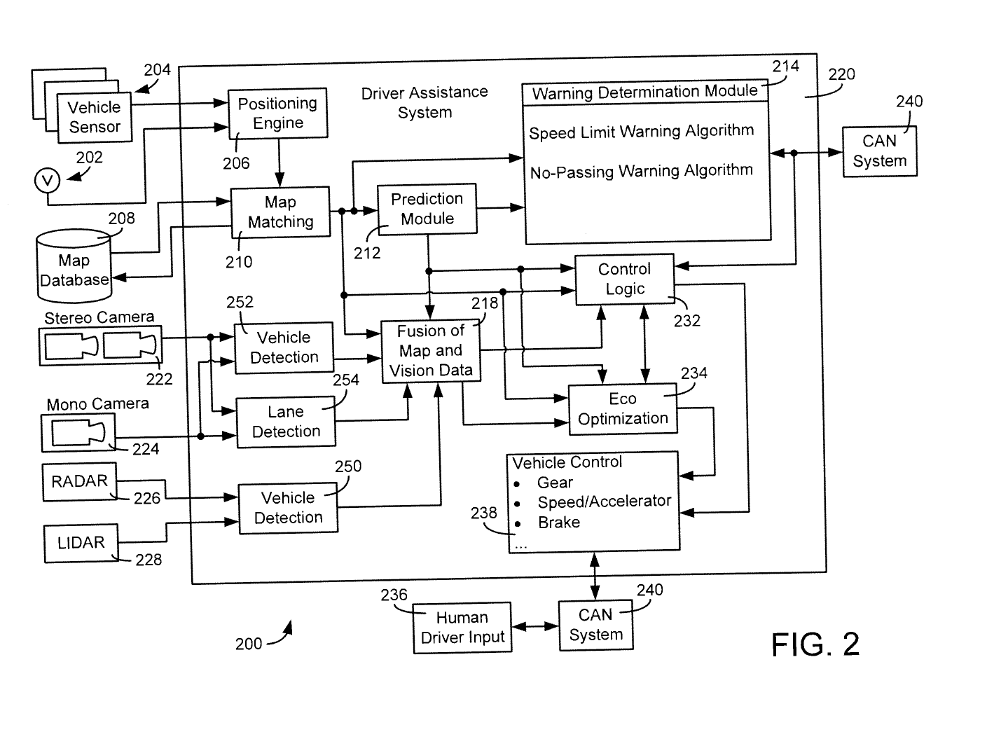

Referring now to FIG. 2, driver assistance system 220 is stored in the memory 104 of central controller 102 according to one embodiment. Driver assistance system 220 includes a map matching module 210. The map matching module 210 includes a map matching algorithm that receives vehicle location data (e.g., latitude, longitude, elevation, etc.) from the GPS unit 202. According to one embodiment, the vehicle location data is enhanced and made more accurate by combining the GPS vehicle location data with vehicle sensor data from at least one vehicle sensor 204 at a positioning engine 206.

According to one exemplary embodiment, vehicle sensor data such as vision data, speed sensor data, and yaw rate data can be combined with GPS data at positioning engine 206 to reduce the set of coordinates that the vehicle may be located to improve the accuracy of the location data. For example, cameras 222 and 224 my be included in vehicle sensors 204 and positioning engine 206 may receive vision data from a camera 222, 224 that has been processed by a lane detection algorithm. According to one embodiment, the lane detection software can modify the received GPS data to indicate that the vehicle is located in a specific lane rather than a general path or road. In addition, other vehicle sensor data such as vision data, speed data, yaw rate data, etc. can be used to further supplement the GPS location data to improve the accuracy of the vehicle location.

Driver assistance system 220 also includes or is functionally connected to a map database 208 which includes navigation characteristics associated with pathways and roadways that may be traveled on by a vehicle. According to one embodiment, the map database 208 includes data not included in the GPS location data such as road elevations, road slopes, degrees of curvature of various road segments, the location of intersections, the location of stop signs, the location of traffic lights, no passing zone locations, yield sign locations, speed limits at various road locations, and various other navigation characteristics, for example.

According to one exemplary embodiment, once the positioning engine 206 has determined an enhanced location of the vehicle, the enhanced vehicle location is forwarded to map matching module 210. The map matching algorithm uses the enhanced location of the vehicle from positioning engine 206 or raw location data from the GPS 202 to extract all navigation characteristics associated with the vehicle location. The navigation characteristics extracted from map database 208 may be used for a variety of application algorithms to add to or enhance a vehicle's active or passive electronic safety systems. The application algorithms may be executed alone (i.e., only used with the map data). Two application algorithms are shown in warning determination module 214, a speed limit warning algorithm and a no passing warning algorithm. These application algorithms may also be executed in connection with a variety of vehicle sensors such as RADAR 226, LIDAR 228, monocular vision 224, stereo vision 224, and various other vehicle sensors 204 to add further functionality. Furthermore, control logic module 232 can include further algorithms to determine how various sensor inputs will cause CAN connected vehicle modules to actuate according to a control signal.

According to one exemplary embodiment, the application algorithms may be used to inform the driver directly via human machine interface (HMI) indicators (e.g., audible indicators, visual indicators, tactile indicators) or a combination of HMI indicators. For example, an audible indicator may alert a driver with a audible sound or message in the case that the speed limit warning algorithm determines the vehicle speed is above a speed limit or is about to exceed a speed limit threshold. In a similar manner, visual indicators may use a display such as an LCD screen or LED light to indicate a warning message and tactile indicators may use a vibration element in a vehicle steering wheel, for example, to alert the driver to a warning message output from the warning determination module 214. Furthermore, the application algorithms may also be provided to a vehicle control module 238 to send a control signal to various vehicle actuators 110, 112, 116, and 122 for example, to directly change how the vehicle operates without human intervention.

In one embodiment of the present disclosure, the driver assistance system 220 is used to provide a zone warning, such as a speed zone warning or no passing zone warning for the driver of the vehicle. According to some embodiments, when a current or predicted vehicle speed is above a threshold speed associated with a zone of the road the vehicle is traveling on or is predicted to travel on, the warning determination module 214 sends a control signal to CAN system 240 to convey a warning indication to driver of the vehicle via an HMI. In some embodiments, the threshold speed is the stored speed limit, while in other embodiments the threshold speed is above the stored speed limit or can be altered by weather conditions or manual driver settings. According to one exemplary embodiment, the speed zone warning is based on known speed zones that are stored in map database 208 for various geographic locations. In addition, in some embodiments, when the vehicle is within a predetermined distance of a road lane detected by lane detection module 234 and the vehicle is also in a no passing zone or will is predicted to be in a no passing zone in a predetermined period of time, the warning determination module 214 sends a control signal to CAN system 240 to convey a warning indication to driver of the vehicle via an HMI.

The speed warning system utilizing GPS data, a vehicle speed sensor, and speed limit data from a map database provides reliable speed zone warning in all illumination and environmental conditions. The speed warning system provides distance, time to and speed limit of an upcoming speed zone for optimal fuel efficiency. Because the speed warning system does not depend on optical sensors, it works reliably in all weather conditions. Eliminating optical sensors reduces the occurrence of false warnings due to false readings. The use of data concerning the speed limit in the forthcoming speed zone from a map database allows the speed warning system to warn the driver before entering a different speed zone. Maintaining vehicle speed at or below the posted speed limit can help increase fuel efficiency, increases driver safety, and helps to reduce insurance costs.

With respect to the no passing zone warning system, if a lane departure is detected by the LDW system, the driver assistance system may alter lane departure warning parameters when it is known via the no passing zone warning algorithms that the departure is in a no passing zone and oncoming traffic may be present. The warning parameters may be altered, for example, in the following ways: increase warning repetition frequency, increase volume of audible tone, add a different audible tone, add haptic, visual, or other warning means, etc.

The no passing zone functionality may also be combined with a lane keeping assist (LKA) system. If the LKA system detects that the vehicle is drifting to the edge of the host or current lane, the driver assistance system may alter lane keeping control parameters when it is known via no passing zone warning algorithms that the vehicle is in a no passing zone and oncoming traffic may be present in the adjacent lane. The control parameters may be altered, for example, in the following ways: increase the control gain, increase the correction torque, add additional warnings to the driver, such as audible, haptic, visual, or other warning means, etc.

A driver assistance system including the no-passing zone functionality described above may have several advantages, including increased reliability in all weather conditions, reduction or elimination of false warnings, and assistance in increasing fuel efficiency. The system may also provide an optimal decision making process for passing, which may increase safety and in turn assist in reducing insurance cost.

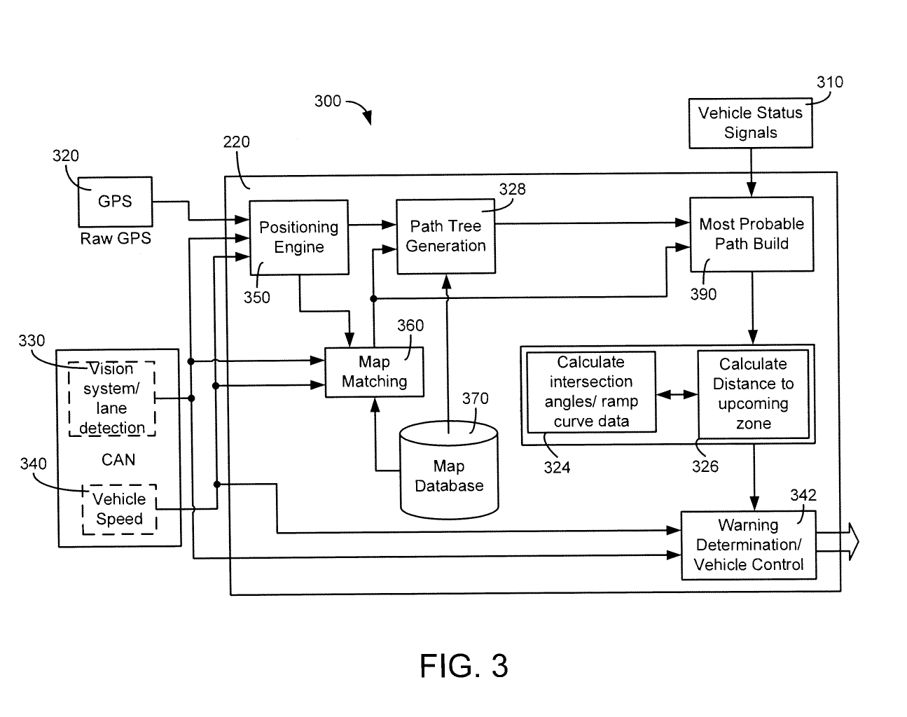

According to one embodiment as shown in FIG. 3, GPS unit 320 provides the current vehicle location to positioning engine or dead reckoning module 350. Module 350 also receives the vehicle speed from sensor 340, if available, the yaw rate of the vehicle from angular rate sensors, if available, and acceleration sensors (accelerometers, not shown), if available, in order to calculate position with better accuracy and produce a higher update rate for map matching module 360, path tree generation module 328, and most probable path build 390.

The resulted fused position map from module 350 allows the driver assistance system 220 to predict vehicle position points for more accurate vehicle route data. The GPS and inertial fusion has the benefits of 1) helping to eliminate GPS multipath and loss of signal in urban canyons, 2) providing significantly better dead reckoning when GPS signal is temporarily unavailable, especially while maneuvering, 3) providing mutual validation between GPS and inertial sensors, and 4) allows the accurate measurement of instantaneous host vehicle behavior due to high sample rate and relative accuracy of the inertial sensors 330, 340. By way of example, the driver assistance system 220 can handle GPS update rates of 5 Hz or greater.

Referring again to FIG. 3, map matching data produced at map matching module 360 provides an output location of a vehicle with respect to a road and navigation characteristics associated with the road including but not limited to no passing zone locations and various speed limits associated with certain road segments. In addition, the stereo vision or monocular vision system provides the forward looking image of the road environment. Such vision system data may be provided directly to map matching module 360 or may be provided at a later step from sensor module 310, for example. A lane detection and tracking algorithm using the stereo vision or monocular vision system calculates host lane position and lane horizontal curvature. The stereo vision system can also calculate a 3D lane profile including vertical curvature, incline/decline angle, and bank angle information. These calculations may be performed at map matching module 360 or may alternatively be performed at various other modules including path tree generation module 328, probable path module 390, curvature calculation module 326, or prediction module 212, fusion module 218, control logic module 232 or warning determination module 214, for example.

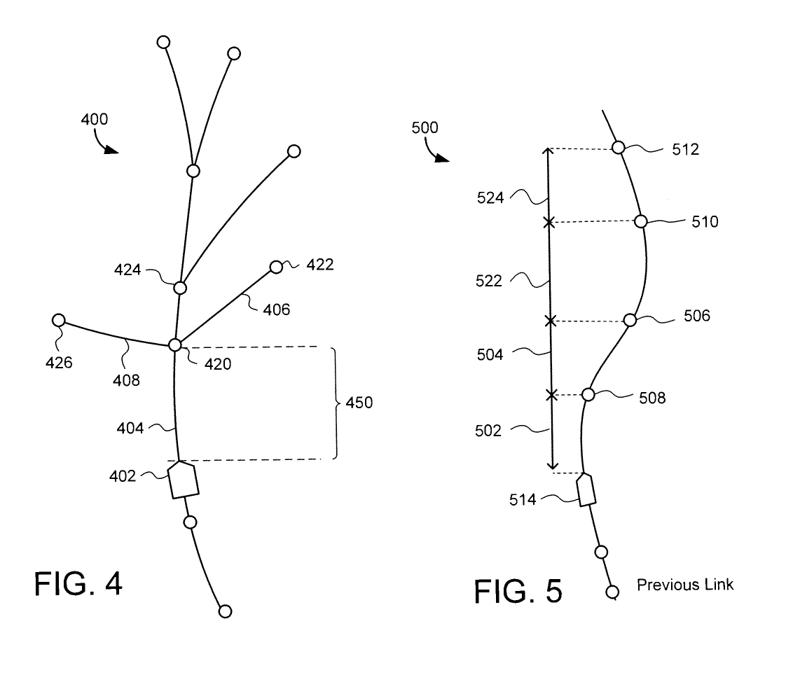

Accordingly, prediction module 200 receives the output of map matching module 210 to generate a path tree 400 including a set of forward paths or roads the vehicle 402 can take such as the path between node 420 and node 426 and the current path the vehicle 402 is on as shown in FIG. 4. Once path tree 400 has been generated, a most probable future path 500 of the vehicle 514 is generated based on the generated path tree, the vehicle data, and the navigation characteristics. In some embodiments, the path tree generation unit 328 organizes the links in a hierarchical fashion, providing quick access to link features important in path prediction, such as intersecting angles and travel direction.

Details of output of the map matching unit 360 that are provided to the most probable path building unit 390 according to one or more embodiments is described below. The map matching unit 360 matches the GPS-processed position of the vehicle output by the positioning engine 350 (which takes into account the inertial sensor data as provided by the sensors 330, 340) to a position on a map in single path and branching road geometry scenarios. In this way, map matching unit 360 provides navigation characteristics, as obtained from the map database 370 to various locations relevant to a vehicle. According to one example, a GPS position is used as an input to a look up table or software algorithm which is used to retrieve navigation characteristics stored in map database 370.

Furthermore, the map matching unit 360 finds the position on the map that is closest to the corrected GPS position provided by module 350, whereby this filtering to find the closest map position can be performed using an error vector based on the last time epoch. GPS heading angle and history weights can be used by the map matching unit 360 in some embodiments to eliminate irrelevant road links. Map matching as performed by the map matching unit 360 can also utilize information regarding the vehicle's intention (e.g., its destination), if available, and also the vehicle trajectory. In some embodiments, map matching can be performed by reducing history weight near branching (e.g., a first road intersection with a second road), and by keeping connectivity alive for a few seconds after branching.

Details of the operation of the most probable path unit 390 according to one or more embodiments is described below. The most probable path unit 390 uses the map-matched position as output by the map matching unit 360 as a reference to look ahead of the host vehicle position, extracts the possible road links, and constructs a MPP (Most Probable Path) from the extracted road links. The MPP construction can be affected by the host vehicle speed. Also, angles between the connected branches making up the MPP are computed and are used with other attributes to determine the ‘n’ MPPs. A path list is then constructed using the ‘n’ MMPs, whereby vehicle status signals as output by the vehicle status signals unit 310 can be used in the selection of the MPPs. Further, a vehicle imaging system can also be utilized in some embodiments to assist in the selection of the MPPs.

FIG. 4 is a diagrammatic representation of the n MPPs that can be output by the most probable path of a vehicle 402, as shown by way of path tree 400 with the various possible paths shown as branches of the tree 400. For example, the path between nodes 420 and 426 as well as the path between 420 and 422 are both possible future paths while subsection 450 between the vehicle location 402 and node 420 is the path tree root. According to one exemplary embodiment the various nodes on the generated path tree 400 are associated with navigation characteristics retrieved from the map database 370 such as road curve data, intersection data, speed limit data, and no passing zone data that may be used to determine if a control signal should be transmitted from the warning determination module 214 or the vehicle control module 238.

As shown in FIG. 3, the time/distance calculation unit 326 also can determine aspects of the n MPPs output by the most probable path unit 390. Time and distance calculations can be performed on one or more of the MPPs output by the most probable path unit 390. In some embodiments, time and distance are calculated using vehicle speed and intermodal distances 502, 504, 522, and 524 as shown in FIG. 5 on a determined MPP 500. For example, if the segment of MPP 500 between node 508 and 506 has a speed limit of 50 m.p.h., zone 504 may have a speed threshold of 60 mph. If vehicle 514 is traveling at a speed of 70 m.p.h. and based on distance 502, time calculation module 324 may be able to determine how long it will take for vehicle 514 to enter zone 504. According to one example if the speed of the vehicle is above the speed threshold and the time until a vehicle reaches a zone is under a time threshold, warning determination module 342 will send a control signal to at least one of an HMI indicator or a vehicle module. Similar calculations may be undertake to warn a driver or control a vehicle module if the zone is a no passing zone. However, in such a case the threshold value would be a threshold distance between the vehicle 514 and a road lane, according to one embodiment.

In addition the control signal may communicate a required deceleration (in the case of a speed zone warning) or steering wheel angle of rotation (in the case of a no passing zone warning) so to bring the determined threshold violation under the threshold value. This required deceleration may be provided to a break control module 112 or engine control module 122, for example, to remove the determined threat. In addition, the threat assessment unit 342 can determine a curvature point of interest and a threat associated therewith, whereby each threat may result in the output of a warning to a vehicle operator, wherein the warning is emitted from an HMI, according to one embodiment.

Furthermore, warning determination module 214 may transmit a control signal to an HMI to convey a warning to a vehicle passenger if one of several thresholds is exceeded. Each algorithm included in warning determination module 214 may have one or more thresholds that are monitored. For example, if the current vehicle speed is over the Department of Transportation (DOT) recommended safe speed for the current road curvature and bank angle as determined by a curve speed warning algorithm, or over the posted warning speed of this curve or if a predicted future vehicle speed is over the DOT recommended safe speed for the upcoming lane curvature and bank angle (or over the posted warning speed of this upcoming curve) that the host vehicle is about to enter in a predefined time threshold (e.g., 10 seconds), a control signal may be transmitted from module 214 to a CAN system 240 to be provided to an HMI.

Additionally, the algorithms depicted in warning control module 214 may use various vehicle data collected by vehicle sensors 204 including camera and radar input to calculate the distance and time to an upcoming curve, which, together with the targeted speed, can be provided to the an automatic control module 232 to produce a vehicle control signal at vehicle control module 238 to automatically adjust vehicle speed/deceleration for optimal fuel efficiency without human intervention. Such automatic adjustments may be transmitted as control signals from vehicle control module 238 and provided to a CAN system 240 which distributes the control signal to an appropriate vehicle module such as an engine control module 122 or a brake control module 110, 112.

Based on the road path information as provided by the GPS 202 and the most probable future path as determined by the prediction module 212, the driver assistance system 220 can accurately inform the operator of the vehicle with suitable lead time about an upcoming road condition that may pose a hazard. For example, if the host vehicle 514 enters a speed zone at a speed that exceeds the speed for that zone, then the vehicle will be in violation of an ordinance or may be driving in an unsafe manner. The driver assistance system 220, according to an embodiment of the invention, can warn the driver if the vehicle is moving too fast, whereby the driver assistance system can provide warnings through a HMI prior to entering a speed zone or no passing zone thereby improving on previous warning systems and methods.

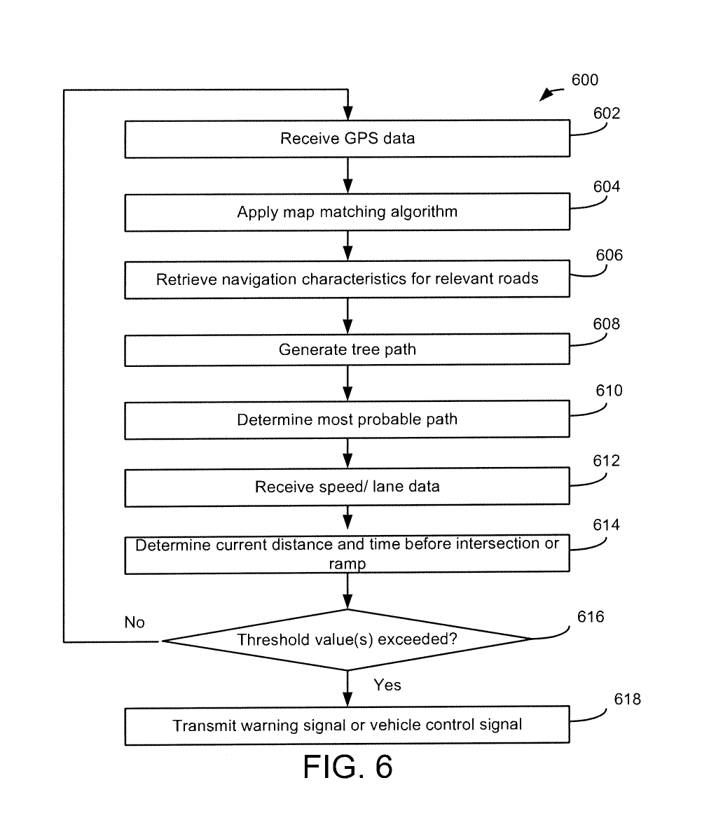

Referring to FIG. 6, a general flow chart of a method for producing a curve related control signal is disclosed. Process 600 may be carried out by several different driver assistance system embodiments 200 or 300 and may be a computer program stored in the memory 104 of central controller 104 and executed by at least one processor 106 in central controller 102. Process 600 is merely exemplary and may include additional steps or may not include one or more steps displayed in FIG. 6. According to one exemplary embodiment, at step 602 driver assistance system 220 receives raw GPS data from GPS unit 202. According to one embodiment, this raw GPS data may be enhanced at positioning engine 206 or dead reckoning module 350, for example. As stated previously, the positioning engine improves the accuracy of raw GPS data provided by GPS unit 202 using vehicle sensor data 204 including data from camera units 222 and 224 as well as from other sensors such as an accelerometer, a vehicle speed sensor 340, or a YAW rate sensor 330.

Once vehicle location data or enhanced vehicle data is determined at step 602, the vehicle location data, which may comprise a set of coordinates, such as longitude and latitude, is provided to a map matching algorithm stored in map matching module 210 for example at step 604. According to one embodiment, the map matching algorithm uses the vehicle position coordinates as a reference to look up navigation characteristics associated with the position coordinates in map database 208. For example, a given coordinate may have an associated elevation above sea level, slope value, road curve measurement, lane data, stop sign presence, no passing zone presence, or speed limit for example. Once step 606 generates a series of relevant location coordinates within a road that are associated with various navigation characteristics, this data is provided to prediction module 212 to generate a path tree at step 608 and a most probable path at step 610. According to one embodiment the most probable path is segmented into a series of nodes, each of which are may be associated with a speed zone and/or a no passing zone as determined by navigation characteristics retrieved from map database 208. According to another embodiment, prediction module 212 may calculate time and distance data for future nodes 510, 512 on the most probable path 500 at step 614 based on vehicle speed and/or lane detection data received at step 612.

The most probable path and associated navigation characteristics such as speed zones and/or no passing zones may then be provided to several other driver assistance modules 218, 232, 234, and 214 for further calculations or processing. According to one embodiment, the most probable path and zone data is transmitted to warning determination module 214 and entered as input to a zone warning algorithm. The zone warning algorithm will analyze the most probable path data and compare the vehicles speed or lane data with a threshold value associated with a most probable path node 506, 508, 510, and 512, for example.

At step 616, process 600 determines if at least one of one more thresholds for a given node have been exceeded. According to one embodiment, if a threshold value has been exceeded warning determination module 214 provides a control signal to CAN system 240, which in turn actuates an HMI to provide a warning or other indication to a vehicle passenger that a dangerous condition is approaching along the most probable path at step 618. Furthermore, step 618 may take place at control logic module 232, eco optimization module 234, or vehicle control module 238 with additional algorithms providing various threshold determinations. For example, vehicle control module 238 may receive the most probable path data from prediction module 212 and determine based on a gear algorithm or braking algorithm whether to actuate a gear control module 116 or brake module 110, 112 by providing a control signal to CAN system 240.

The present disclosure has been described with reference to example embodiments, however persons skilled in the art will recognize that changes may be made in form and detail without departing from the spirit and scope of the disclosed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the exemplary embodiments is manifestly intended to be as broad as possible. For example, unless specifically otherwise noted, the exemplary embodiments reciting a single particular element also encompass a plurality of such particular elements.

Exemplary embodiments may include program products comprising computer or machine-readable media for carrying or having machine-executable instructions or data structures stored thereon. For example, the driver monitoring system may be computer driven. Exemplary embodiments illustrated in the methods of the figures may be controlled by program products comprising computer or machine-readable media for carrying or having machine-executable instructions or data structures stored thereon. Such computer or machine-readable media can be any available media which can be accessed by a general purpose or special purpose computer or other machine with a processor. By way of example, such computer or machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of computer or machine-readable media. Computer or machine-executable instructions comprise, for example, instructions and data which cause a general purpose computer, special purpose computer, or special purpose processing machines to perform a certain function or group of functions. Software implementations of the present invention could be accomplished with standard programming techniques with rule based logic and other logic to accomplish the various connection steps, processing steps, comparison steps and decision steps.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

1. A driver assistance system for providing driver and vehicle feedback control signals comprising:
a map database comprising navigation characteristics related to road locations;
a GPS unit that receives location data of the vehicle;
a map matching module configured to receive the location data of the vehicle and retrieve navigation characteristics relevant to the location data using a processing circuit;
a prediction module configured to generate a most probable future path for the vehicle and to determine the locations of upcoming zones on the most probable future path;
a vehicle sensor unit configured to generate vehicle speed data; and
a warning module configured to determine if the vehicle speed data exceeds a speed threshold associated with the upcoming zone on the most probable path.

2. The driver assistance system of claim 1, wherein the zone is a speed zone on the future most probable path.

3. The driver assistance system of claim 1, wherein the warning module is further configured to:
determine the distance between the current vehicle location and the upcoming zone on the most probable path; and
determine the time remaining before the vehicle reaches the upcoming zone on the most probable path based on the determined distance and the vehicle speed data.

4. The driver assistance system of claim 1, wherein the warning module transmits a control signal to a vehicle module via a vehicle control area network if the vehicle speed data exceeds a speed threshold associated with the upcoming zone.

5. The driver assistance system of claim 1, wherein the warning module transmits a control signal to a human machine interface via a vehicle control area network if a predicted future vehicle speed exceeds a speed threshold of an upcoming zone on the most probable future path.

6. The driver assistance system of claim 3, wherein the warning module transmits a control signal to a human machine interface via a vehicle control area network based on the time remaining before the vehicle reaches the upcoming zone and the vehicle speed.

7. The driver assistance system of claim 1, further comprising a vehicle control module that transmits a control signal to at least one vehicle module via a vehicle control area network if a predicted future vehicle speed exceeds a speed threshold of an upcoming zone on the most probable future path.

8. The driver assistance system of claim 7, wherein the at least one vehicle module is at least one of an engine control module, a gear control module, and a brake control module.

9. The driver assistance system of claim 3, further comprising a vehicle control module that transmits a control signal to at least one vehicle module via a vehicle control area network based on the time remaining before the vehicle reaches the upcoming zone and the vehicle speed.

10. The driver assistance system of claim 6, wherein the human machine interface comprises at least one of an audible indicator, a visual indictor, and a tactile indicator.

11. The driver assistance system of claim 1, wherein the zone is a no-passing zone on the future most probable path.

12. The driver assistance system of claim 11, further comprising:
a vehicle vision system configured to generate vision data; and
a lane detection module configured to analyze the vision data and identify driving lanes in the most probable future path.

13. The driver assistance system of claim 12, wherein the warning module is further configured to transmit a control signal to a human machine interface if the vehicle has entered a no passing zone and the vehicle comes within a predetermined distance of an identified driving lane.

14. The driver assistance system of claim 12, wherein the warning module is further configured to transmit a control signal to a human machine interface if the vehicle is predicted to enter a no passing zone and the vehicle comes within a predetermined distance of an identified driving lane.

15. A method of assisting a driver of a vehicle by providing driver and vehicle feedback control signals, the method comprising:
receiving location data of the vehicle from a GPS unit;
retrieving navigation characteristics stored in a map database based on the location data;
generating a most probable future path for the vehicle;
determining the locations of upcoming zones on the most probable future path based on the retrieved navigation characteristics using a processor;
generating vehicle speed data at a vehicle sensor unit; and
determining if the vehicle speed data exceeds a speed threshold associated with the upcoming zone on the most probable path.

16. The method of claim 15, wherein the zone is a speed zone on the future most probable path.

17. The method of claim 15, further comprising:
determining the distance between the current vehicle location and the upcoming zone on the most probable path; and
determining the time remaining before the vehicle reaches the upcoming zone on the future most probable path based on the determined distance and the vehicle speed data.

18. The method of claim 15, further comprising:
transmitting a control signal to a vehicle module via a vehicle control area network if the vehicle speed data exceeds a speed threshold associated with the upcoming zone.

19. The method of claim 15, further comprising:
transmitting a control signal to a human machine interface via a vehicle control area network if a predicted future vehicle speed exceeds a speed threshold of an upcoming zone on the most probable future path.

20. The method of claim 17, further comprising transmitting a control signal to a human machine interface via a vehicle control area network based on the time remaining before the vehicle reaches the upcoming zone and the vehicle speed.

21. The method of claim 15, further comprising transmitting a control signal to at least one vehicle module via a vehicle control area network if a predicted future vehicle speed exceeds a speed threshold of an upcoming zone on the most probable future path.

22. The method of claim 21, wherein the at least one vehicle module is at least one of an engine control module, a gear control module, and a brake control module.

23. The method of claim 17, further comprising transmitting a control signal to at least one vehicle module via a vehicle control area network based on the time remaining before the vehicle reaches the upcoming zone and the vehicle speed.

24. The method of claim 20, wherein the human machine interface comprises at least one of an audible indicator, a visual indictor, and a tactile indicator.

25. The method of claim 15, wherein the zone is a no-passing zone on the future most probable path.

26. The method of claim 25, further comprising:
generating vision data at a vehicle vision system; and
analyzing the vision data to identify driving lanes in the most probable future path.

27. The method of claim 26, further comprising transmitting a control signal to a human machine interface if the vehicle has entered a no passing zone and the vehicle comes within a predetermined distance of an identified driving lane.

28. The method of claim 26, further comprising transmitting a control signal to a human machine interface if the vehicle is predicted to enter a no passing zone and the vehicle comes within a predetermined distance of an identified driving lane.
